(19) United States
(12) Patent Application Publication
(10) Pub. No.: US 2019/0054942 A1
(43) Pub. Date: Feb. 21, 2019

(54) METHODS AND SYSTEMS FOR DECENTRALIZED TRAIN CONTROL

(71) Applicant: Metrom Rail, LLC, Crystal Lake, IL (US)

(72) Inventor: Richard C. Carlson, Village of Lake in the Hills, IL (US)

(21) Appl. No.: 16/055,905

(22) Filed: Aug. 6, 2018

Related U.S. Application Data
(60) Provisional application No. 62/541,454, filed on Aug. 4, 2017.

(51) Int. Cl. B61L 27/04; B61L 15/00; B61L 27/00

(52) U.S. Cl. CPC B61L 27/04; B61L 15/009; B61L 15/0072; H04L 67/12; B61L 27/0005; B61L 2205/00; B61L 27/0061

(57) ABSTRACT

Systems and methods are provided for decentralized train control. A decentralized train system may include a plurality of wayside control units, configured for placement on or near tracks in a railway network, and one or more train-mounted units, each of which being configured for use in a particular train. Each wayside control unit may obtain information corresponding to each train that passes within its communication range, and provide obtained train-related information to each train-mounted unit passing within its communication range. Each train-mounted unit may configured to receive train-related information from each wayside control unit that comes within its communication range, process the received train-related information, assess based on the processing of the train-related information conditions relating to operation of train within the railway network, and when at least one condition meets one or more particular criteria, perform or cause performing one or more responsive actions.

### CLAIM OF PRIORITY

This patent application makes reference to, claims priority to and claims benefit from U.S. Provisional Patent Application Ser. No. 62/541,454, filed on Aug. 4, 2017. The above identified application is hereby incorporated herein by reference in its entirety.

### BACKGROUND

Aspects of the present disclosure relate to safety solutions particularly in conjunction with railway systems. More specifically, various implementations of the present disclosure relate to methods and systems for decentralized train control.

In this regard, various issues may exist with conventional approaches for controlling trains. In this regard, conventional systems and methods, if any existed, for controlling trains (e.g., to prevent accidents), particularly in transmit systems, may be costly, inefficient, and cumbersome.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for wireless train communication, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 illustrates an example conventional train control system.

FIG. 2 illustrates an example decentralized train control system, in accordance with the present disclosure.

FIG. 3 illustrates an example wayside control node, in accordance with the present disclosure.

FIG. 4 illustrates an example train-mounted unit, in accordance with the present disclosure.

### DETAILED DESCRIPTION OF THE INVENTION

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

In accordance with the present disclosure, trains (e.g., in transit systems) may be controlled in automated and decentralized manner. In this regard, most existing public transit systems do not have automated safety systems to prevent accidents. Automated safety systems typically will prevent accidents caused by non-compliance of signal lights, speeding, end-of-line incursions, improper track usage, and other operating rule infractions such as following too closely. Reasons for lack of proper automated safety systems may include extreme cost and installation difficulties associated with new system installations. In various implementations in accordance with the present disclosure, automated and decentralized train control (e.g., signaling) systems may be used. Further, system signaling systems may be implemented in manner that addresses issues typically affecting use and deployment of new systems—for example, reducing system costs (e.g., by up to 75%) and reducing installation time (e.g., by over 50%), as to justify use and adoption of these solutions.

An example system for providing and/or supporting decentralized control operations in a railway network, in accordance with the present disclosure, may comprise a plurality of wayside control units, configured for placement on or near tracks in the railway network, and one or more train-mounted units, with each train-mounted unit being configured for use in a particular train. Each wayside control unit may be configured to obtain information corresponding to each train that passes within communication range of the wayside control unit, and to provide obtained train-related information to each train-mounted unit that passes within communication range of the wayside control unit. Each train-mounted unit may be configured to receive train-related information from each wayside control unit that comes within communication range of the train-mounted unit, process the received train-related information, assess based on the processing of the train-related information one or more conditions relating to operation of train within the railway network, and when at least one condition meets one or more particular criteria, perform or cause performing one or more responsive actions.

In an example implementation, wayside control units may be configured to receive at least a portion of train related information from at least one train-mounted unit.

In an example implementation, wayside control units may be configured to autonomously determine at least a portion of train related information corresponding to at least one train.

In an example implementation, each train-mounted unit may maintain unique identification information associated with a corresponding train and a route assigned to the train within the railway network. Each train-mounted unit may then communicate the unique identification information to each wayside control unit that comes within communication range of the train-mounted unit.

In an example implementation, the plurality of wayside control units and the one or more train-mounted units may be configured for supporting and/or utilizing ultra-wideband (UWB) based communications.

In an example implementation, the train-mounted units may be configured to, when the one or more responsive actions comprise providing indication or feedback, relating to the at least one condition, monitor actions of the train operator, assess based on the monitoring, the train operator's handling of at least one expected subsequent responsive action, and directly perform the at least one expected subsequent responsive action when the train operator fails to do so.

An example wayside control device configured for use in a decentralized train control system, in accordance with the present disclosure, may comprise a housing for enclosing components of the wayside control device, a communication component, comprising one or more antennas, configured for transmitting and/or receiving wireless signals, and one or more circuits configured for processing signals and data, and for performing functions relating to operations of the wayside control device within the decentralized train control system. The wayside control device is configured for placement on or near tracks. Further, the wayside control device is configured to obtain information corresponding to each train operating with a railway network managed using the decentralized train control system, when the train passes within communication range of the wayside control device, and to provide train-related information associated with one train to at least one other train, when the at least one other train passes within communication range of the wayside control device.

In an example implementation, the wayside control device may be configured for supporting and/or utilizing ultra-wideband (UWB) based communications.

In an example implementation, the wayside control device may comprise one or more radio-frequency identification (RFID) tags configured for uniquely identifying the wayside control device within the railway network.

In an example implementation, the wayside control device may comprise a support structure for holding and/or supporting the wayside control device when placed on or near the tracks.

In an example implementation, the wayside control device may comprise a power component for supplying and/or obtaining power for components of the wayside control device.

In an example implementation, the wayside control device may comprise one or more sensory components, for detecting, monitoring, and/or tracking trains.

An example train-mounted device configured for use within a train to support a decentralized train control system, in accordance with the present disclosure, may comprise a housing for enclosing components of the train-mounted device, a communication component, comprising one or more antennas, configured for transmitting and/or receiving wireless signals, one or more input/output (I/O) components, for receiving input from an operator of the train and/or for providing output to the operator of the train, and one or more circuits configured for processing signals and data, and for performing functions relating to operations of the train-mounted device within the decentralized train control system. The train-mounted device may be configured to, during operation of the train within a railway network managed using the decentralized train control system, receive train-related information from one or more wayside control units in the decentralized train control system, when coming within communication range of the train-mounted device, process the received train-related information, assess based on the processing of the train-related information one or more conditions relating to operation of the train within the railway network, and when at least one condition meets one or more particular criteria, perform or cause performing one or more responsive actions.

In an example implementation, the train-mounted device may be configured to, when the one or more responsive actions comprise providing indication or feedback, relating to the at least one condition, to a train operator, monitor actions of the train operator, assess based on the monitoring, the train operator's handling of at least one expected subsequent responsive action, and directly perform the at least one expected subsequent responsive action when the train operator fails to do so.

In an example implementation, the train-mounted device may be configured for supporting and/or utilizing ultra-wideband (UWB) based communications.

In an example implementation, the train-mounted device may comprise an radio-frequency identification (RFID) reader configured for interacting with RFID tags in wayside control units of the decentralized train control system.

In an example implementation, the train-mounted device may comprise a power component for supplying and/or obtaining power for components of the train-mounted device.

In an example implementation, the train-mounted device may comprise an interface component for connecting to and/or interfacing with other systems of the train.

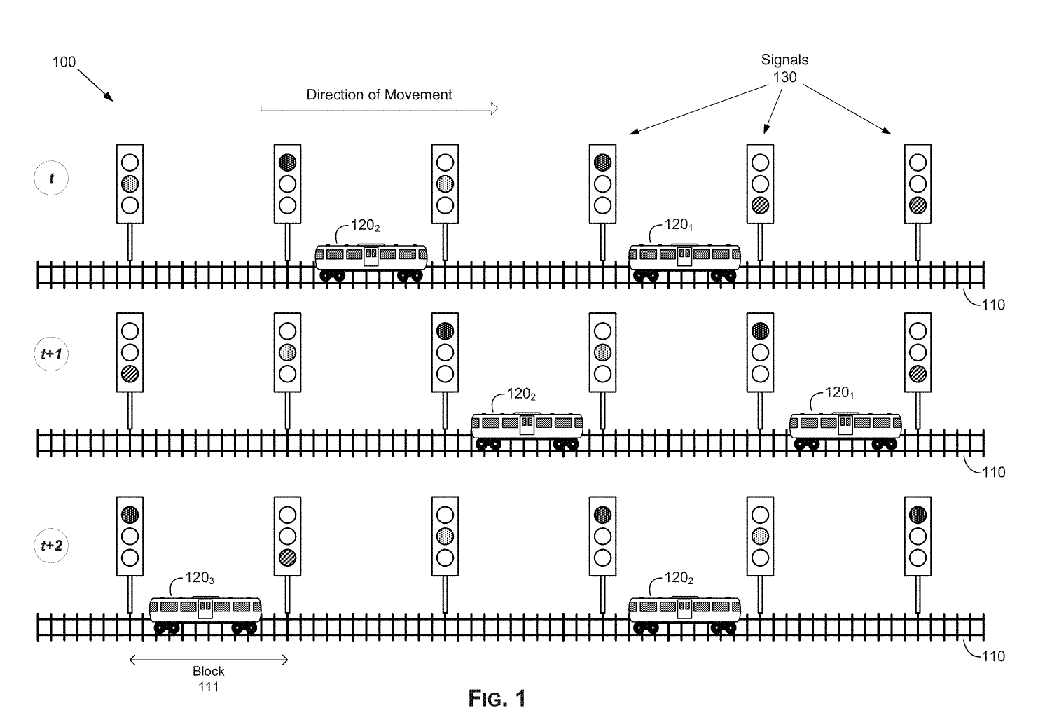

FIG. 1 illustrates an example conventional block-based train control system. Shown in FIG. 1 is a conventional block-based train control system 100, and an example use scenario thereof.

In accordance with conventional block-based designs and implementations, a track 110 may be segmenting into a plurality of segments (or “blocks”) 111. Trains 120 using the track 110 may then be controlled, such as using signals 130, based on the blocks in which they are present at any given point and/or the blocks that they would be moving into. In this regard, the signal 130 may be configured to provide visual indications, which may allow train operators to control the train correspondingly. For example, as shown in FIG. 1, the signals 130 may have 3 light indications, red (top), yellow (middle), and green (bottom).

Thus, a particular train (e.g., train 120₁) may be allowed to enter a particular block 111, when the signal 130 associated with that block indicate that the block 111 is empty; otherwise, if the block is not empty (or if there is a reason to prevent entry to the block) the signal 130 indicate to the train that it may not enter the block. For example, if a train is in a block, the signal 130 would indicate red, and the next train would not be cleared to enter until the block was unoccupied.

The conventional block-based systems may be configured to control operations of trains based on blocks—e.g., maintaining the minimum number (e.g., two) of empty blocks between consecutive trains. For example, the signal 130 may indicate yellow if the block is empty but the proceeding train (e.g., train 120₁) had not cleared a particular safety threshold (e.g., still in the next block), and would indicate green if the block is empty and the proceeding train cleared the safety threshold.

These conventional block-based systems may have various drawbacks, however. For example, one of the drawbacks of conventional block-based systems is the efficiency or “headway” caused by the non-uniform spacing required between trains, which may ultimately require more trains and operators to resolve.

Existing alternatives to the fixed block systems may include centralized safety control systems, such as positive train control (PTC) and communication based train control (CBTC) based systems. In this regard, rather than utilize fixed blocks, the centralized safety control systems may rely on a backbone of wayside sensors, which must be connected to a centralized control center, where decisions are made based on information received from the wayside sensors. The decisions are then sent out to every train. Accordingly, in these systems, control of the entire train system is centralized into a control hub.

Such centralized safety control systems have their own drawbacks, however. In particular, these systems are generally very expensive, and difficult to install and maintain, as virtually the entire signaling system must be replaced. Further, because most transit agencies only allow for a few hours of down time to perform maintenance and upgrades overnight, It is virtually impossible to implement this type of system to an existing line without severely impacting service.

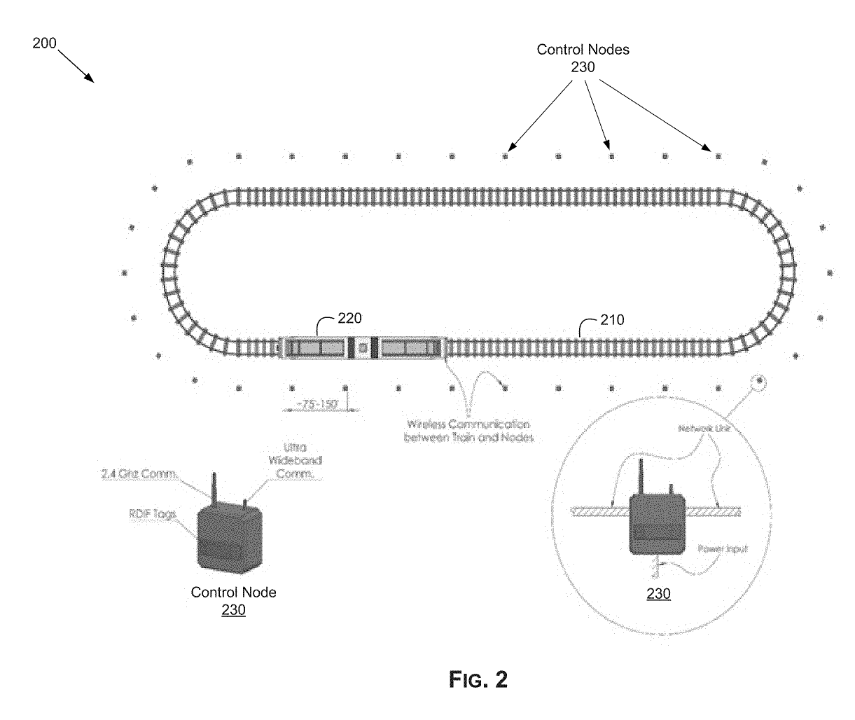

Accordingly, in various implementations in accordance with the present disclosure, decentralized and automated control systems may be used to control trains in transit systems. An example implementation is described with respect to FIG. 2.

FIG. 2 illustrates an example decentralized train control system, in accordance with the present disclosure. Shown in FIG. 2 is a decentralized train control system 200.

In decentralized train control systems in accordance with the present disclosure, such as the decentralized train control system 200 of FIG. 2, the required control-related processing (e.g., to assess obtained information, to make decisions based obtained information, etc.) is distributed, and located on each train, thus negating the requirement for centralized decision hubs. Use of such decentralized approach greatly simplifies installation requirements.

For example, as shown in the example implementation illustrated in FIG. 2, rather than utilizing the conventional “blocks” as described above, control nodes 230 may be used instead in controlling trains 220 traveling on tracks 210 (e.g., in transit systems). The control nodes 230 may be placed wayside on or near the tracks (e.g., track 210 in FIG. 2), such as every 75-200 feet. In this regard, spacing between the control nodes 230 may be adaptively determined, such as based on the braking profiles of the trains.

During operations in the system, the trains (e.g., train 220 in FIG. 2) communicate with the control nodes 230 wirelessly. The control nodes 230 may be inter-connected, such as via wireless and/or wired networks, for communications therebetween.

The trains 220 may be configured for operation in such decentralized train control systems. For example, the train 200 may incorporate a dedicated train-mounted control equipment rack for supporting decentralized train control. The train-mounted control equipment rack may comprise suitable hardware (including, e.g., circuitry), software, or any combination thereof, configured for supporting decentralized train control related operations or functions.

The train-mounted control equipment rack may comprise, for example, ultra-wideband (UWB) ranging component, communication radio(s), radio-frequency identification (RFID) reader, power supply, processing unit(s), braking interface, positioning (e.g., global navigation satellite system (GNSS), such as global positioning system (GPS)) component, data recorder, personality controller, operator interface, worker protection interface, etc., as well as expansion slots (for any additional components that may be needed in the future).

In an example implementation, the train-mounted control equipment rack may be about 16″ wide×6″×6″. An operator interface may comprise a display and several switches the operator utilizes for interfacing with the system, as well as the appropriate communication antenna for the UWB as well as communication links and redundant wheel speed sensors.

Nonetheless, in some implementations, rather than using an train-mounted control equipment rack that incorporate all the above-described components, already present on the train may be used and (re-)configured accordingly to support the decentralized control functions described in this disclosure.

Each of the control nodes 230 may comprise suitable hardware (including, e.g., circuitry), software, or any combination thereof, configured for supporting decentralized train control related operations or functions. Each control node 230 may comprise, for example, RFID tag, GNSS (e.g. GPS) component, ultra-wideband (UWB) radio, communication radio, radar transceiver, communications bus interface, camera interface, central processing unit, etc.

The control nodes 230 may be configured to optimize (reduce) size. For example, the control nodes 230 may be configured such that each node may fit into a 6″ square cube, and be located on the wayside—e.g., mounted to the sides of subway tunnels, located on a stand which is approximately 3-4 feet high, etc. Integrated antennas will also be mounted to the unit for the UWB and Com links.

In operation, each train 200 may be assigned a route number which will indicate proper track, station stops, and speed limit information. This data will then be transferred to the control nodes 230 as the train moves through the system. Thus, when passed by the train 220, the control nodes 230 may record that a train has passed as well as related pertinent information (e.g., train's direction, speed, and unique identifier). In other words, the control nodes 230 acting as a “bread crumb” trail telling the train its location, and activating switches to control its route.

Following trains may communicate with the control nodes 230 to determine spacing, route timing, and track authorities. Accordingly, the entire system may rely on train-centric control which will be dictated by the operating rules and procedures loaded into the train's processor module.

When conditions (e.g., unsafe condition, accident, etc.) are detected in the operation of the train, the system will respond accordingly—e.g., notifying the operator, and if the operator takes no action, the system may directly cause actions to be taken, if deemed necessary—e.g., cause the train to apply the brakes until the non-conformance is resolved. This may be done by interacting with the braking the system, via brake interface, for example.

In an example implementation, for added reliability (e.g., to meet the rail industries' required safety and reliability requirements), decentralized train control system in accordance with the present disclosure in accordance may be configured such that they are “fail safe” in design and construction. For example, “fail safe” may be accomplished by utilizing both redundant components and subsystems as well as providing totally redundant operation of parallel sensing systems.

Table 1 (below) illustrates example redundancy configuration with respect to a number of example activities or conditions that may be monitored using such decentralized control system:

TABLE 1
redundancy configuration for various
activities in train control systems

| | Primary | Secondary | Tertiary |
|---|---|---|---|
| Activity | method | method | method |
| Signal compliance | UWB radio | Common radio | Node logic |
| | link | link | |
| Speed limit | RFID tags | UWB radio | Wheel sensors |
| compliance | | link | |
| Collision avoidance | UWB radio | RFID tags | Node logic |
| | link | | |
| Track authority | RFID tags | Node logic | UWB radio |
| | | | link |

Accordingly, various implementations in accordance with the present disclosure may provide train-centric systems with processing power and decision making on the trains. Further, “micro” blocks may be used to allow closer spacing of trains. Control nodes, combining several sensor functions into a compact package may be utilized. Further, use of adaptive learning techniques (e.g., utilizing artificial intelligence) may be utilized. Thus, control nodes may be able to “learn” as data is gathered which will be utilized to optimize the systems operations.

Further, systems implemented in accordance with the present disclosure may be fully integrated—e.g., train control system operation may be fully integrated with other solutions, such as roadway worker protection, security, unauthorized intrusion, and other features not currently available in existing solutions (e.g., PTC/CBTC systems), such as end of line protection, precision platform berthing, etc.

In some instances, system parameters may be adjusted, such as based local weather conditions (e.g., when raining), braking distances can be adjusted upwards, during high temperature periods, cornering speeds can be slowed, etc. The proposed systems may be configured for modularity and flexibility. For example, these systems may be constructed with each feature may be implemented using plug-in module (to allow adding or removing features with ease).

This allows future adoption of additional features without affecting existing hardware installations (which is not currently available in the industry). The train-mounted system can perform diagnostics monitoring acceleration and braking curves of trains over time, as well as wheel maintenance. The control nodes may be configured to establish a node network, which may be utilized for track maintenance activities such as providing an electronic path for track inspections using automated vehicles such as drones.

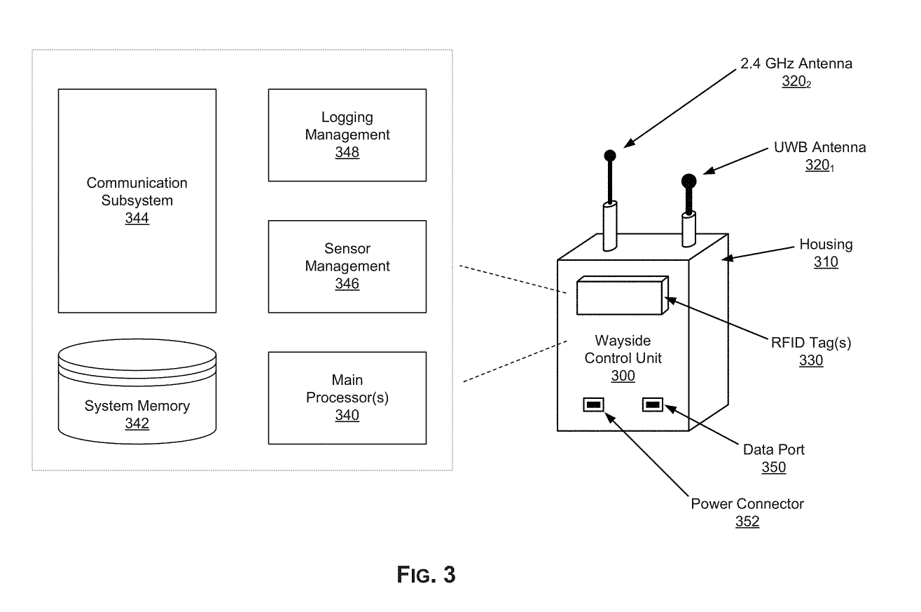

FIG. 3 illustrates an example wayside control node, in accordance with the present disclosure. Shown in FIG. 3 is a wayside control unit 300.

The wayside control unit 300 may comprise one or more of suitable circuity, hardware, software, and combination thereof for implementing various aspects of the present disclosure, particularly with respect to the decentralized control of trains, as described above. In this regard, the wayside control unit 300 may be a particular example implementation of the control node 230, as described with respect to FIG. 2.

In the example implementation illustrated in FIG. 3, the wayside control unit 300 may comprise a housing 310 for enclosing various components of the wayside control unit 300 and/or allowing attachment to certain external elements or structures. The housing 310 may be constructed to be suitable for the intended operation environment and/or conditions of the wayside control unit 300 (e.g., being constructed to be very rigid, as to withstand accidental impacts during deployment), and to withstand environmental conditions associated with outside/external use (e.g., rain, extreme cold/heat), etc.). The wayside control unit 300 has one or more antennas 320, used in transmitting and/or receiving signals. In particular, the wayside control unit 300 may comprise an ultra-wideband (UWB) communication port/antenna 320₁, and a 2.4 GHz communication port/antenna 320₂.

The wayside control unit 300 may also comprise one or more RFID tags 330, which may be used to facilitate RFID based interactions with the trains.

In some implementations, the wayside control unit 300 may incorporate sensory elements, such as for use in monitoring, detecting, and tracking trains (e.g., to detect approaching train), using one or more suitable technologies (e.g., visual, infrared, laser ranging, etc.), and/or to enable generating corresponding data (distance, relative speed, etc.).

Further, while not shown in FIG. 3, The wayside control unit 300 typically would also comprise (or can be coupled to) a support structure, to enable placement of the wayside control unit 300, such as on or near train tracks.

Internally, the wayside control unit 300 may comprise suitable circuitry for performing various operations in support of its functions. For example, the wayside control unit 300 may comprise one or more main processors 340, a system memory 342, a communication subsystem 344, a sensor management component 346, and a logging management component 348.

Each main processor 340 may comprise suitable circuitry operable to process data, and/or control and/or manage operations of the wayside control unit 300, and/or tasks and/or applications performed therein. In this regard, the main processor 340 may configure and/or control operations of various components and/or subsystems of the wayside control unit 300, by utilizing, for example, one or more control signals. The main processor 340 may comprise a general purpose processor (e.g., CPU), a special purpose processor (e.g., application-specific integrated circuit (ASIC)), or the like. The disclosure, however, is not limited to any particular type of processors. The main processor 340 may enable running and/or execution of applications, programs and/or code, which may be stored, for example, in the system memory 342. Alternatively, one or more dedicated application processors may be utilized for running and/or executing applications (or programs) in the wayside control unit 300.

The system memory 342 may comprise suitable circuitry for permanent and/or non-permanent storage, buffering, and/or fetching of data, code and/or other information, which may be used, consumed and/or processed. In this regard, the system memory 342 may comprise different memory technologies, including, for example, read-only memory (ROM), random access memory (RAM), Flash memory, solid-state drive (SSD), and/or field-programmable gate array (FPGA). The disclosure, however, is not limited to any particular type of memory or storage devices. The system memory 342 may store, for example, configuration data, which may comprise parameters and/or code, comprising software and/or firmware, logging data, etc.

The communication subsystem 344 may comprise suitable circuitry operable to communicate signals from and/or to the electronic device, such as via one or more wired and/or wireless connections. In this regard, the communication subsystem 344 may be configured to support one or more wired or wireless interfaces, protocols, and/or standards, and to facilitate transmission and/or reception of signals to and/or from the wayside control unit 300, and/or processing of transmitted and/or received signals, in accordance with the applicable interfaces, protocols, and/or standards. Examples of signal processing operations that may be performed by the communication subsystem 344 comprise, for example, filtering, amplification, analog-to-digital conversion and/or digital-to-analog conversion, up-conversion/down-conversion of baseband signals, encoding/decoding, encryption/decryption, and/or modulation/demodulation. For example, the communication subsystem 344 may be configured to support broadcast of alert related signals, via the antenna(s) 320.

The sensor management component 346 may comprise suitable circuitry for managing sensors that may be incorporated into and/or used by the wayside control unit 300. For example, the sensor management component 346 may control the selection of sensory functions, set the parameters required for operation of the sensor(s), and/or process information obtained via the sensor(s).

The logging management component 348 may comprise suitable circuitry for managing logging operations in the wayside control unit 300. The logging operations may comprise compiling log files (stored in the system memory 342) containing data relating to alerts, as described above.

The wayside control unit 300 may also comprise a data port 350, for use in facilitate data interaction with the unit—e.g., for extracting data (e.g., log files) from and/or inputting data (e.g., (re)configuration data) into the wayside control unit 300. Also, the wayside control unit 300 may comprise a power connector 352, for use in obtaining power—e.g., allowing connecting the wayside control node to available power sources. Alternatively or additionally, however, the wayside control node may incorporate dedicated power supply sources (not shown).

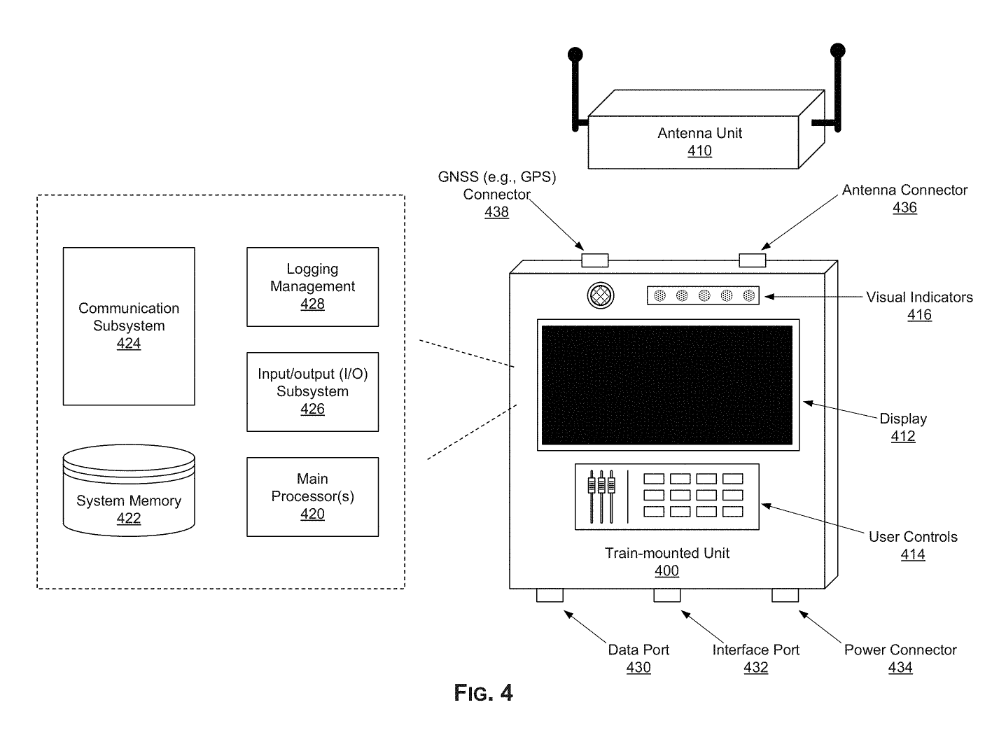

FIG. 4 illustrates an example train-mounted unit, in accordance with the present disclosure. Shown in FIG. 4 is a train-mounted unit 400.

The train-mounted unit 400 may comprise one or more of suitable circuitry, hardware, software, and any combination thereof for implementing various aspects of the present disclosure, particularly with respect to the train-based functionality in support of decentralized train control systems.

In some implementations, train-mounted units may be implemented as singular devices (that is, within a single housing incorporating and/or attaching all components of the train-mounted unit), in other implementations, such as the example implementation illustrated in FIG. 4, train-mounted units may be implemented in a distributed manner—e.g., comprising a plurality of physical units, each of which may be placed at particular location and/or position, selected for optimal performance with respect to functions and/or operations provided by that unit.

For example, as shown in FIG. 4, a separate antenna unit 410 may be used. In this regard, the train-mounted unit antenna unit 410 may comprise one or more antennas (and related circuitry and/or support hardware), configured for use in transmitting and/or receiving signals. In some implementations, however, the train-mounted unit antenna unit 410 may not incorporate dedicated antennas, and may instead simply comprise connecting means (e.g., coaxial connectors for wiring) to existing and/or external antennas in the train.

The train-mounted unit 400 may comprise components for supporting interactions with the train operator—e.g., to received user input and/or provide user feedback relating to operation of the train-mounted unit 400 and/or to alerts. For example, the train-mounted unit 400 may comprises input/output (I/O) components (and related circuitry and/or support hardware), such as a display 412, user controls 414, etc. to enable user interactions. Further, the train-mounted unit 400 may comprise and/or be operable to utilize I/O components configured for providing indications relating to triggering of alerts and/or receiving feedback (e.g., confirmation) relating to such indications.

For example, the train-mounted unit 400 may comprise a speaker (not shown), configured for providing audible indications of triggered alerts, visual indicators (e.g., LEDs) 416, configured for providing visual indications (e.g., alerts). The user controls 414 may comprise various types of user input elements, such as buttons, dials, etc. for allowing train operator(s) or device users to provide input, such as to configure the train-mounted unit 400 and/or its operations, to respond to alerts (when triggered), etc. The user controls 414 may be implemented in the form of a touch screen (e.g., as part of the display 412), or be implemented with an alpha-numeric display. The display 412 (or any type of user interface) may be used to provide the train operator with various information, such as information relating to other trains and/or alerts.

In some instances, rather than incorporating dedicated I/O components, the train-mounted unit 400 (or the train-mounted unit 400) may be operable to connect to and use existing I/O components (e.g., displays, speakers, etc.) in the train, thus obviating the need to (and cost of) incorporating such dedicated components. For example, the train-mounted unit 400 may be operable to utilize existing audio systems to provide audible indication of triggered alerts.

Internally, the train-mounted unit 400 may comprise suitable circuitry for performing various operations in support of its functions. For example, the train-mounted unit 400 may comprise, one or more main processors 420, a system memory 422, a communication subsystem 424, an input/output (I/O) subsystem 426, and a logging management component 428.

Each main processor 420 may comprise suitable circuitry operable to process data, and/or control and/or manage operations of the train-mounted unit 400, and/or tasks and/or applications performed therein. In this regard, the main processor 420 may configure and/or control operations of various components and/or subsystems of the train-mounted unit 400, by utilizing, for example, one or more control signals. The main processor 420 may comprise a general purpose processor (e.g., CPU), a special purpose processor (e.g., application-specific integrated circuit (ASIC)), or the like. The disclosure, however, is not limited to any particular type of processors. The main processor 420 may enable running and/or execution of applications, programs and/or code, which may be stored, for example, in the system memory 422. Alternatively, one or more dedicated application processors may be utilized for running and/or executing applications (or programs) in the train-mounted unit 400.

The system memory 422 may comprise suitable circuitry for permanent and/or non-permanent storage, buffering, and/or fetching of data, code and/or other information, which may be used, consumed and/or processed. In this regard, the system memory 422 may comprise different memory technologies, including, for example, read-only memory (ROM), random access memory (RAM), Flash memory, solid-state drive (SSD), and/or field-programmable gate array (FPGA). The disclosure, however, is not limited to any particular type of memory or storage devices. The system memory 422 may store, for example, configuration data, which may comprise parameters and/or code, comprising software and/or firmware, logging data, etc.

The communication subsystem 424 may comprise suitable circuitry operable to communicate signals from and/or to the electronic device, such as via one or more wired and/or wireless connections. In this regard, the communication subsystem 424 may be configured to support one or more wired or wireless interfaces, protocols, and/or standards, and to facilitate transmission and/or reception of signals to and/or from the train-mounted unit 400, and/or processing of transmitted and/or received signals, in accordance with the applicable interfaces, protocols, and/or standards. Examples of signal processing operations that may be performed by the communication subsystem 424 comprise, for example, filtering, amplification, analog-to-digital conversion and/or digital-to-analog conversion, up-conversion/down-conversion of baseband signals, encoding/decoding, encryption/decryption, and/or modulation/demodulation. For example, the communication subsystem 424 may be configured to support broadcast of alert related signals, via the antenna(s).

The I/O subsystem 426 may comprise suitable circuitry for managing user interactions with the train-mounted unit 400, such as to enable obtaining input from and/or providing output to device user(s). The I/O subsystem 426 may support various types of inputs and/or outputs, including, for example, video, audio, tactile, and/or textual. In this regard, dedicated I/O devices and/or components, external to (and coupled with) or integrated within the train-mounted unit 400, may be utilized for inputting and/or outputting data during operations of the I/O subsystem 426. Examples of such dedicated I/O devices may comprise user interface components or devices (e.g., the display 412), audio I/O components (e.g., speakers and/or microphones), mice, keyboards, touch screens (or touchpads), and the like. In some instances, user input obtained via the I/O subsystem 426, may be used to configure and/or modify various functions of particular components or subsystems of the train-mounted unit 400.

The logging management component 428 may comprise suitable circuitry for managing logging operations in the train-mounted unit 400. The logging operations may comprise compiling log files (stored in the system memory 422) containing data relating to alerts, as described above.

As shown in the example implementation illustrated in FIG. 4, the train-mounted unit 400 may be implemented as multi-unit system, comprising multiple separate components (the main unit and the train-mounted unit antenna unit 410). In this regard, as noted each of the different physical sub-units may be configured for placement at particular location and/or position, selected for optimal performance with respect to functions and/or operations provided by that unit.

For example, the train-mounted unit 400 may be configured for placement within the operator compartment (e.g., train cockpit) at position optimal for providing output to and/or receiving input from the operator (e.g., top of the dashboard), whereas the train-mounted unit antenna unit 410, may be configured for placement outside (and on top) of the engine car.

Accordingly, as the train-mounted unit 400 may house the bulk of the resources (e.g., processing resources, storage resources, etc.), and to enable connectivity to and/or communication with other individual sub-units (if any) and/or other resources in the train, the train-mounted unit 400 may comprise connectors, ports, and other suitable devices to enable such connectivity and/or communications.

For example, the train-mounted unit 400 may comprise a data port 430, for enabling connecting to the train-mounted unit 400 for extracting data therefrom (e.g., log files) and/or inputting data thereto (e.g., for (re)configuration), one or more interface connectors 434, for connecting to and interfacing with other systems in the train (e.g., the braking system), a power connector 434 (e.g., for use drawing power from sources within the train), one or more antenna connectors 436 (e.g., for connecting to the train-mounted unit antenna unit 410, existing antennas in the train, etc.), one or more GNSS connectors 438, for connecting to existing GNSS systems (or transceivers), etc.

Also, while not shown in FIG. 4, the train-mounted unit 400 may also comprise component for managing power operations—e.g., handling supply of power to the train-mounted unit 400 itself, and/or to other units, such as the train-mounted antenna unit 410. In this regard, power may be obtained, for example, from the train, such as via the power connector 434. Alternatively or additionally, however, the train-mounted unit 400 may incorporate dedicated power supply sources (not shown).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for providing decentralized control operations in a railway network, the system comprises:
a plurality of wayside control units, configured for placement on or near tracks in the railway network; and
one or more train-mounted units, wherein each train-mounted unit is incorporated into a particular train;
wherein:
each wayside control unit is configured to:
obtain information corresponding to each train that passes within communication range of the wayside control unit; and
provide obtained train-related information to each train-mounted unit that passes within communication range of the wayside control unit; and
each train-mounted unit is configured to:
receive train-related information from each wayside control unit that comes within communication range of the train-mounted unit;
process the received train-related information;
assess based on the processing of the train-related information one or more conditions relating to operation of train within the railway network; and
when at least one condition meets one or more particular criteria, perform or cause performing one or more responsive actions.

2. The system of claim 1, wherein the wayside control unit receives at least a portion of train related information from at least one train-mounted unit.

3. The system of claim 1, wherein the wayside control unit autonomously determine at least a portion of train related information corresponding to at least one train.

4. The system of claim 1, wherein each train-mounted unit maintains unique identification information associated with a corresponding train and a route assigned to the train within the railway network.

5. The system of claim 4, wherein each train-mounted unit communicates the unique identification information to each wayside control unit that comes within communication range of the train-mounted unit.

6. The system of claim 1, wherein the plurality of wayside control units is configured for supporting and/or utilizing ultra-wideband (UWB) based communications.

7. The system of claim 1, wherein the one or more train-mounted units are configured for supporting and/or utilizing ultra-wideband (UWB) based communications.

8. The system of claim 1, wherein, when the one or more responsive actions comprise providing indication or feedback, relating to the at least one condition, to a train operator, the train-mounted unit is configured to:
monitor actions of the train operator;
assess based on the monitoring, the train operator's handling of at least one expected subsequent responsive action; and
directly perform the at least one expected subsequent responsive action when the train operator fails to do so.

9. A wayside control device, configured for use in a decentralized train control system, the wayside control device comprising:
a housing for enclosing components of the wayside control device;
a communication component, comprising one or more antennas, configured for transmitting and/or receiving wireless signals; and
one or more circuits operable to:
process signals and data, and
perform one or more functions relating to operations of the wayside control device within the decentralized train control system;
wherein:
the wayside control device is configured for placement on or near tracks; and
the wayside control device is configured to:
obtain information corresponding to each train operating with a railway network managed using the decentralized train control system, when the train passes within communication range of the wayside control device; and
provide train-related information associated with one train to at least one other train, when the at least one other train passes within communication range of the wayside control device.

10. The wayside control device of claim 9, wherein the communication component is configured for supporting and/or utilizing ultra-wideband (UWB) based communications.

11. The wayside control device of claim 9, comprising one or more radio-frequency identification (RFID) tags configured for uniquely identifying the wayside control device within the railway network.

12. The wayside control device of claim 9, comprising a support structure for holding and/or supporting the wayside control device when placed on or near the tracks.

13. The wayside control device of claim 9, comprising a power component for supplying and/or obtaining power for components of the wayside control device.

14. The wayside control device of claim 9, comprising one or more sensory components, for detecting, monitoring, and/or tracking trains.

15. A train-mounted device, configured for use within a train to support a decentralized train control system, the train-mounted device comprising:
a housing for enclosing components of the train-mounted device;
a communication component, comprising one or more antennas, configured for transmitting and/or receiving wireless signals;
one or more input/output (I/O) components, for receiving input from an operator of the train and/or for providing output to the operator of the train; and
one or more circuits operable to:
process signals and data, and
perform one or more functions relating to operations of the train-mounted device within the decentralized train control system;
wherein the train-mounted device is configured to, during operation of the train within a railway network managed using the decentralized train control system:
receive train-related information from one or more wayside control units in the decentralized train control system, when coming within communication range of the train-mounted device;
process the received train-related information;
assess based on the processing of the train-related information one or more conditions relating to operation of the train within the railway network; and
when at least one condition meets one or more particular criteria, perform or cause performing one or more responsive actions.

16. The train-mounted device of claim 15, wherein, when the one or more responsive actions comprise providing indication or feedback, relating to the at least one condition, to a train operator, the train-mounted unit is configured to:
monitor actions of the train operator;
assess based on the monitoring, the train operator's handling of at least one expected subsequent responsive action; and
directly perform the at least one expected subsequent responsive action when the train operator fails to do so.

17. The train-mounted device of claim 15, wherein the communication component is configured for supporting and/or utilizing ultra-wideband (UWB) based communications.

18. The train-mounted device of claim 15, wherein the communication component comprises an radio-frequency identification (RFID) reader configured for interacting with RFID tags in wayside control units of the decentralized train control system.

19. The train-mounted device of claim 15, comprising a power component for supplying and/or obtaining power for components of the train-mounted device.

20. The train-mounted device of claim 15, comprising an interface component for connecting to and/or interfacing with other systems of the train.
